(19) United States
(12) Patent Application Publication
(10) Pub. No.: US 2014/0344512 A1
(43) Pub. Date: Nov. 20, 2014

(54) Data Processing Apparatus and Memory Apparatus

(71) Applicant: Yamaha Corporation, Hamamatsu-shi (JP)

(72) Inventor: Naotoshi NISHIOKA, Hamamatsu-shi (JP)

(73) Assignee: Yamaha Corporation, Hamamatsu-shi (JP)

(21) Appl. No.: 14/280,926

(22) Filed: May 19, 2014

(30) Foreign Application Priority Data
May 20, 2013 (JP) 2013-105872

(51) Int. Cl. G06F 3/06; G06F 13/18; G06F 13/16

(52) U.S. Cl. CPC G06F 3/0659; G06F 13/1668; G06F 13/18; G06F 3/061; G06F 3/0673; G06F 2003/0697
USPC 711/105

(57) ABSTRACT

A data processing apparatus includes bus masters and a memory controller. Each bus master includes a data buffer, and issues a memory command to specify access to the memory and generates first priority information depending on a free space of the data buffer, wherein the first priority information is associated with the memory command and indicates a priority of the memory command. The memory controller determines a processing order of memory commands which are issued by the plurality of bus masters based on the first priority information corresponding to the memory commands, and executes the respective memory commands transferred from the plurality of bus masters in the processing order determined by the processing order determining unit.

### CROSS REFERENCE TO RELATED APPLICATIONS

The present application is based on and claims the benefit of Japanese patent application No. 2013-105872, filed on May 20, 2013, the contents of which are incorporated herein by reference in its entirety.

### BACKGROUND OF THE INVENTION

1. Field of the Invention

The present invention relates to a data processing apparatus and a memory apparatus that control access to a memory, such as a dynamic random access memory (DRAM).

2. Description of the Related Art

In recent years, a dynamic random access memory (DRAM) has been used as a large-capacity and high-speed access memory in a data processing apparatus in many cases. In the DRAM, however, the throughput is reduced due to access across banks, switching between writing and reading, and the like.

In view of those, a data processing apparatus is known which suppresses a reduction in throughput by rearranging the processing order of memory commands with reference to the type of each memory command, which specifies the writing or reading of data issued by the bus master, and the memory address to be accessed. However, since a memory command for which an access latency is increased occurs due to the rearrangement, there is a problem in that the worst value of the access latency is increased.

Therefore, a technique for setting the priority of the processing of the memory command, which is to be issued, in advance for each bus master is known. According to this technique, memory commands are rearranged and executed based on the priority that is set in advance in a fixed manner for each bus master. The technique aims at realizing a short latency by issuing a memory command to each bus master based on the priority set for each bus master.

In addition, as a technique for suppressing an increase in memory access latency that occurs when contention of memory accesses made by a plurality of bus masters occurs, the following technique is disclosed in JP-A-2007-48274, for example. That is, in the technique disclosed in JP-A-2007-48274, in response to memory access requests issued by a plurality of bus masters, a plurality of commands smaller than a transfer unit of the memory access requests are generated. Then, the plurality of commands is alternately issued to each request source of the memory access request for the memory. That is, JP-A-2007-48274 discloses a memory controller that executes a plurality of memory access requests in a time-division in parallel.

### SUMMARY OF THE INVENTION

When causing each bus master to issue a memory command based on the priority set for each bus master, a number of memory commands of high priorities may be issued since the priorities are fixed and not changed. As a result, a state close to the random data access can occur in the DRAM. In addition, such a state can cause frequent access penalty. That is, if a number of memory commands to requiring a short latency are issued, the throughput of the data processing apparatus is reduced. In addition, the technique disclosed in JP-A-2007-48274 is just making a plurality of memory access requests in a time-division in parallel. Therefore, it is not possible to suppress a situation where the memory commands of high priorities are issued.

It is one of objects of the present invention to avoid a situation where the state close to the random data access to a memory occurs by suppressing the number of issues of the memory command of high priority and to realize a data processing apparatus of high throughput and a short latency with the simple configuration.

A first aspect of the present invention provides a data processing apparatus, including: a plurality of bus masters; and a memory controller that is connected to the plurality of bus masters and a memory in which data is stored to transfer the data, wherein the memory controller is adapted to control at least one of writing of data to the memory and reading of data from the memory, wherein each of the plurality of bus masters includes: a command issuing unit that is adapted to issue a memory command to specify access to the memory; a data buffer; and a priority information generating unit that is adapted to generate first priority information depending on a free space of the data buffer, wherein the first priority information is associated with the memory command and indicates a priority of the memory command, and the memory controller includes: a processing order determining unit that is adapted to determine a processing order of memory commands which are issued by the plurality of bus masters based on the first priority information corresponding to the memory commands; and a command processing unit that is adapted to execute the respective memory commands transferred from the plurality of bus masters in the processing order determined by the processing order determining unit.

According to the data processing apparatus in the first aspect of the present invention, a memory command being associated with the first priority information, which indicates the processing order determined in accordance with the free space of the data buffer provided in each bus master, is issued by each bus master. In this case, even if contention occurs between a plurality of memory commands issued by a plurality of bus masters, the memory commands are executed in appropriate order. Accordingly, the throughput of the data processing apparatus as a whole is improved.

That is, according to the data processing apparatus in the first aspect, a timing suitable for issuing a memory command is detected in accordance with the free space of the data buffer provided in each bus master, and the memory command is issued using the timing. Accordingly, compared with a data processing apparatus in the related art that issues no memory command until the data buffer becomes empty, in other words, until the processing of the bus master is in a standby state, it is possible to greatly increase the number of issues of the memory command. Therefore, the aspect described above can be also applied to a data processing apparatus including a so-called latency critical bus master.

That is, according to the data processing apparatus in the first aspect, it is possible to suppress a situation where a number of memory commands of high priorities are issued. As a result, it is possible to avoid a situation where the state close to the random data access to a memory occurs and to realize a data processing apparatus of high throughput and a short latency with the simple configuration. The state where there is no free space in the write data buffer and the state where the read data buffer is completely empty are one of the factors that deteriorate the throughput and latency of the data processing apparatus. In the data processing apparatus according to the first aspect, high throughput and a short latency are realized by reducing the frequency at which such a state occurs.

A second aspect of the present invention provides a data processing apparatus according to the first aspect, wherein the memory controller includes a priority information acquisition unit that is adapted to acquire second priority information which defines an order for preferentially processing the memory commands for each bus master that issues the memory commands, and the processing order determining unit determines the processing order of the memory commands based on either the first priority information or the second priority information in accordance with an instruction from an outside of the memory controller.

By adopting such a configuration, the data processing apparatus can perform switching between the mode in which the processing order of memory commands is determined based on the first priority information and the mode in which the processing order of memory commands is determined based on the second priority information. As a result, it is possible to set the processing order of memory commands in consideration of viewpoints other than the viewpoint of improving the throughput of the data processing apparatus as a whole. That is, in addition to the processing as to improve the throughput of the data processing apparatus as a whole, the memory command issued by the specific bus master can be always processed with a predetermined priority. As the predetermined priority, for example, the highest priority can be mentioned.

A third aspect of the present invention provides a data processing apparatus according to the first or second aspect, wherein the data buffer includes a write data buffer in which write data to be written in the memory is stored, the command issuing unit issues a write command as the memory command when the write data is written to the memory, and the priority information generating unit generates the first priority information which defines that a write command issued when a free space of the write data buffer is small is executed in preference to a write command issued when the free space is large.

By adopting such a configuration, it is possible to rearrange the processing order of write commands appropriately based on the free space of the write data buffer. That is, when the free space of the write data buffer is small, in other words, when a write command should be quickly processed, the bus master issues a write command being associated with the first priority information of high priority. That is, it is possible to greatly reduce the frequency at which the state where there is no free space in the write data buffer occurs. In contrast, when the free space of the write data buffer is large, in other words, when it is not necessary to quickly process a write command, the bus master issues a write command being associated with the first priority information of low priority. Thus, since the degree of freedom in the rearrangement of memory commands is increased, the throughput of the data processing apparatus as a whole is improved.

A fourth aspect of the present invention provides a data processing apparatus according to any one of the first to third aspects, wherein the data buffer includes a read data buffer in which read data to be read from the memory is stored, the command issuing unit issues a read command as the memory command when the read data is read from the memory, and the priority information generating unit generates the first priority information which defines that a read command issued when a free space of the read data buffer is large is executed in preference to a read command issued when the free space is small.

By adopting such a configuration, when a free space is generated in the read data buffer, the bus master issues a read command of the priority depending on the size of the free space. That is, the bus master issues a read command so that the small free space generated in the read data buffer is not useless. Accordingly, it is possible to greatly reduce the frequency at which the state where the read data buffer is completely empty occurs. In addition, it is possible to issue the read command being associated with the first priority information of low priority. That is, it is possible to issue a number of read commands of low priorities at an appropriate timing instead of issuing the read commands of high priorities sporadically as in the data processing apparatus in the related art.

A fifth aspect of the present invention provides a data processing apparatus according to any one of the first to fourth aspects, wherein the memory is a dynamic random access memory (DRAM).

A sixth aspect of the present invention provides a memory apparatus, including: a memory in which data is stored; a plurality of bus masters; and a memory controller that is connected to the plurality of bus masters and the memory to transfer the data, wherein the memory controller is adapted to control at least one of writing of data to the memory and reading of data from the memory, wherein each of the plurality of bus masters includes: a command issuing unit that is adapted to issue a memory command to specify access to the memory; a data buffer; and a priority information generating unit that is adapted to generate first priority information depending on a free space of the data buffer, wherein the first priority information is associated with the memory command and indicates a priority of the memory command, and the memory controller includes: a processing order determining unit that is adapted to determine a processing order of memory commands which are issued by the plurality of bus masters based on the first priority information corresponding to the memory commands; and a command processing unit that is adapted to execute the respective memory commands transferred from the plurality of bus masters in the processing order determined by the processing order determining unit.

### BRIEF DESCRIPTION OF THE DRAWINGS

In the accompanying drawings:

FIG. 1 is a block diagram showing an example of the configuration of a data processing apparatus according to an embodiment of the present invention;

FIG. 2 is a diagram showing an example of the configuration of a bus master provided in the data processing apparatus shown in FIG. 1;

FIG. 3 is a timing chart showing an example of the priority information generation process performed by the data processing apparatus according to the embodiment of the present invention;

FIG. 4 is a graph of a temporal change in the free space of each read data buffer provided in a plurality of bus masters;

FIG. 5 is a diagram showing the concept of the process for the rearrangement of the processing order of read commands that is performed by a DRAM controller when contention occurs between a plurality of read commands.

### DETAILED DESCRIPTION OF THE EXEMPLARY EMBODIMENTS

Hereinafter, a data processing apparatus according to an embodiment of the present invention will be described with reference to the accompanying drawings.

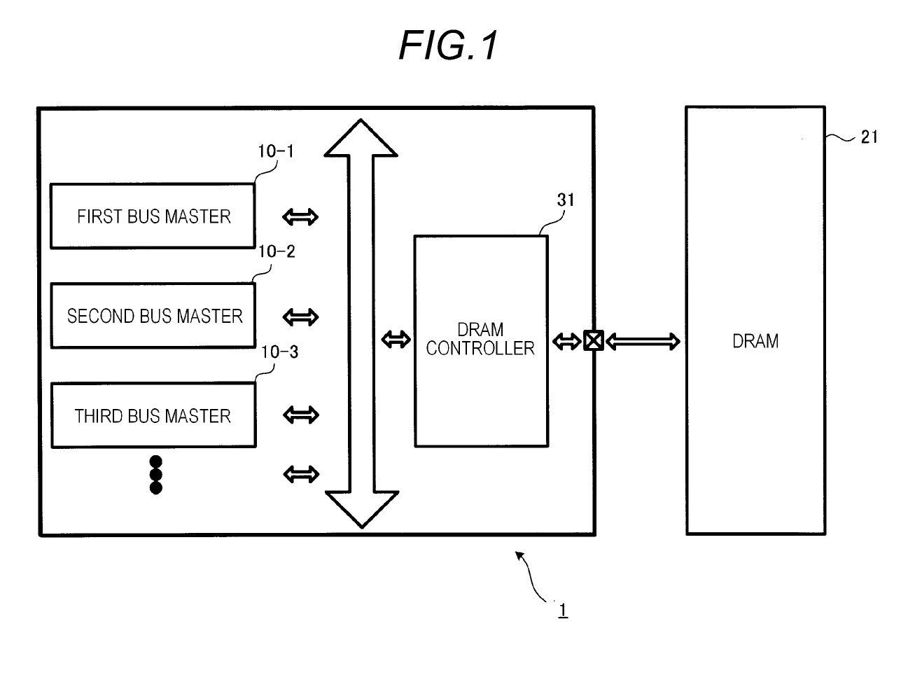

FIG. 1 is a block diagram showing an example of the configuration of a data processing apparatus according to the embodiment of the present invention. A data processing apparatus 1 is an apparatus that performs writing and reading of data with respect to a DRAM (dynamic random access memory) 21, and includes a plurality of bus masters and a DRAM controller 31. In this example, a first bus master 10-1, a second bus master 10-2, and a third bus master 10-3 are adopted as a plurality of bus masters. However, types of bus masters or the number of bus masters is not limited to this. These components are communicably connected to each other through control lines and data lines, such as internal buses. In addition, an apparatus including the data processing apparatus 1 and the DRAM 21 (memory) may be called a “memory apparatus”.

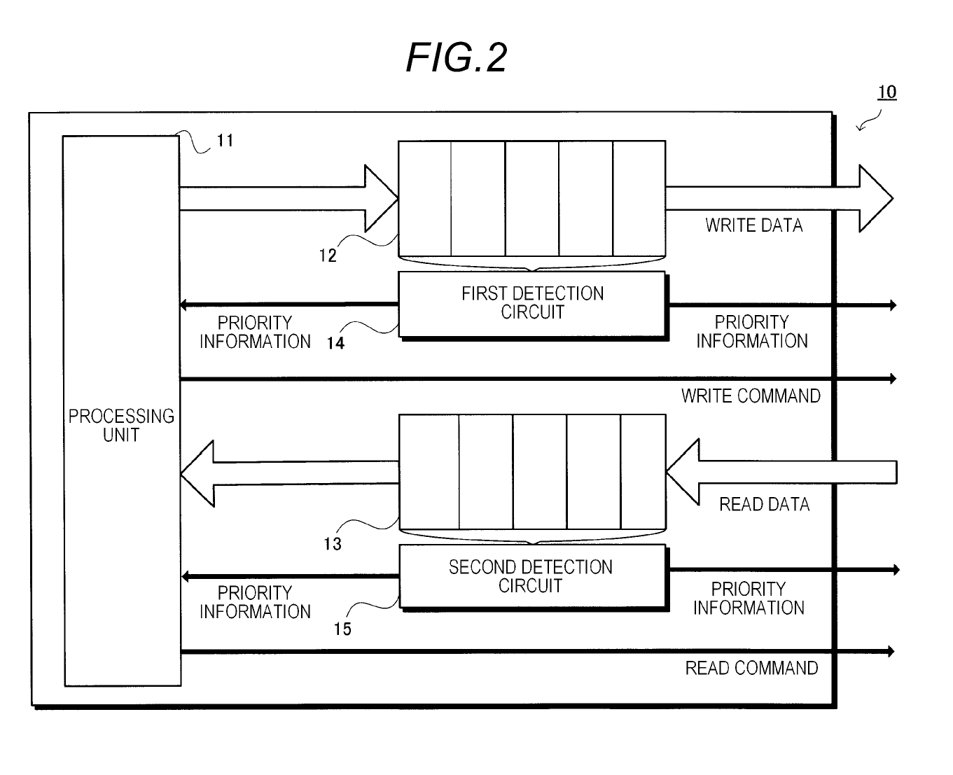

The first bus master 10-1 is a central processing unit (CPU), for example. The second bus master 10-2 is a module that performs image processing, for example. The third bus master 10-3 is a module that performs sound processing, for example. Hereinafter, when describing issues common to the first to third bus masters 10-1 to 10-3, these are referred to collectively as a “bus master 10”. The configuration of the bus master 10 will be described in detail later with reference to FIG. 2. The DRAM 21 receives memory commands issued by a plurality of bus masters provided in the data processing apparatus 1.

The DRAM controller 31 is a memory controller that controls the DRAM 21 according to the memory command issued by the bus master 10. That is, the DRAM controller 31 controls the writing of data to the DRAM 21 and the reading of data from the DRAM 21. The DRAM controller 31 is connected to the bus master 10 and the DRAM 21 through control lines and data lines. The control lines are used for transmission and reception of control signals, such as the memory command, and data lines are used for transmission and reception of data to be written/read. That is, the DRAM controller 31 inputs and outputs data through the data lines based on a control signal transmitted and received through the control lines.

The DRAM controller 31 functions as a processing order determination unit that determines the processing order of memory commands, which are issued by a plurality of bus masters 10, based on the priority information being associated with the memory commands, and functions as a command processing unit that executes each memory command issued from the plurality of bus masters 10 in the processing order determined by the processing order determination unit.

The “priority information” is information that determines the execution order of memory commands, and is information generated by the bus master 10. In the data processing apparatus 1 according to the present embodiment, priority information in which priorities are defined based on the free space of a write data buffer 12 and a read data buffer 13 is generated in association with the memory command. Accordingly, it is possible to greatly reduce the frequency at which the write data buffer 12 becomes full and the frequency at which the read data buffer 13 becomes empty (refer to FIG. 2).

The state where there is no free space in the write data buffer 12 and the state where the read data buffer 13 is completely empty are one of the factors that deteriorate the throughput and latency of the data processing apparatus. In the data processing apparatus 1 according to the present embodiment, high throughput and a short latency are realized by reducing the frequency at which such a state occurs.

FIG. 2 is a block diagram showing an example of the configuration of the bus master 10. As shown in FIG. 2, the bus master 10 includes a processing unit 11, the write data buffer 12, a first detection circuit 14, the read data buffer 13, and a second detection circuit 15.

The processing unit 11 issues a command for writing data to the DRAM 21 (hereinafter, referred to as a write command) and a command for reading data from the DRAM 21 (hereinafter, referred to as a read command) as memory commands. In other words, the processing unit 11 functions as a command issuing unit that issues a memory command to specify the access to the DRAM 21.

When writing data to the DRAM 21, the processing unit 11 outputs, from the bus master 10, write data to be written, a write command including the address information of the writing destination in the DRAM 21, and priority information generated by the first detection circuit 14 in association with each other.

When reading data from the DRAM 21, the processing unit 11 outputs, from the bus master 10, a read command including the address information on the DRAM 21, in which the read data to be read is stored, and priority information generated by the second detection circuit 15 in association with each other.

In addition, the processing specific to the processing unit 11 of each of the bus masters 10-1, 10-2, and 10-3 is the following processing, for example. The processing unit 11 of the first bus master 10-1 performs control processing according to each unit block of the data processing apparatus 1. The processing unit 11 of the second bus master 10-2 performs image processing. The processing unit 11 of the third bus master 10-3 performs sound processing.

The write data buffer 12 temporarily stores the write data output from the processing unit 11 prior to issuing the write command, and then outputs the write data to the DRAM 21 through the DRAM controller 31. The read data buffer 13 temporarily stores the read data, which is read from the DRAM 21 based on the read command issued by the processing unit 11 and is transmitted from the DRAM controller 31, and then outputs the read data to the processing unit 11.

The first detection circuit 14 detects the free space of the write data buffer 12, generates priority information depending on the free space, and outputs the priority information to the processing unit 11 and the DRAM controller 31.

That is, the first detection circuit 14 functions as a priority information generating unit that generates priority information, which is associated with each memory command and indicates the priority of each memory command, depending on the free space of the write data buffer 12. That is, when the free space of the write data buffer 12 is detected, the first detection circuit 14 gives priority depending on the free space to the memory command.

The second detection circuit 15 detects the free space of the read data buffer 13, generates priority information depending on the free space, and outputs the priority information to the processing unit 11 and the DRAM controller 31.

That is, the second detection circuit 15 functions as a priority information generating unit that generates priority information, which is associated with each memory command and indicates the priority of each memory command, depending on the free space of the read data buffer 13. That is, when the free space of the read data buffer 13 is detected, the second detection circuit 15 gives priority depending on the free space to the memory command.

The process of generating the priority information by the first detection circuit 14 and the second detection circuit 15 is one of the features of the data processing apparatus 1 according to the present embodiment. That is, in the data processing apparatus 1 according to the present embodiment, the free space of the write data buffer 12 and the read data buffer 13 is monitored, and priority information depending on the size of free space is generated in association with the memory command when the free space is generated.

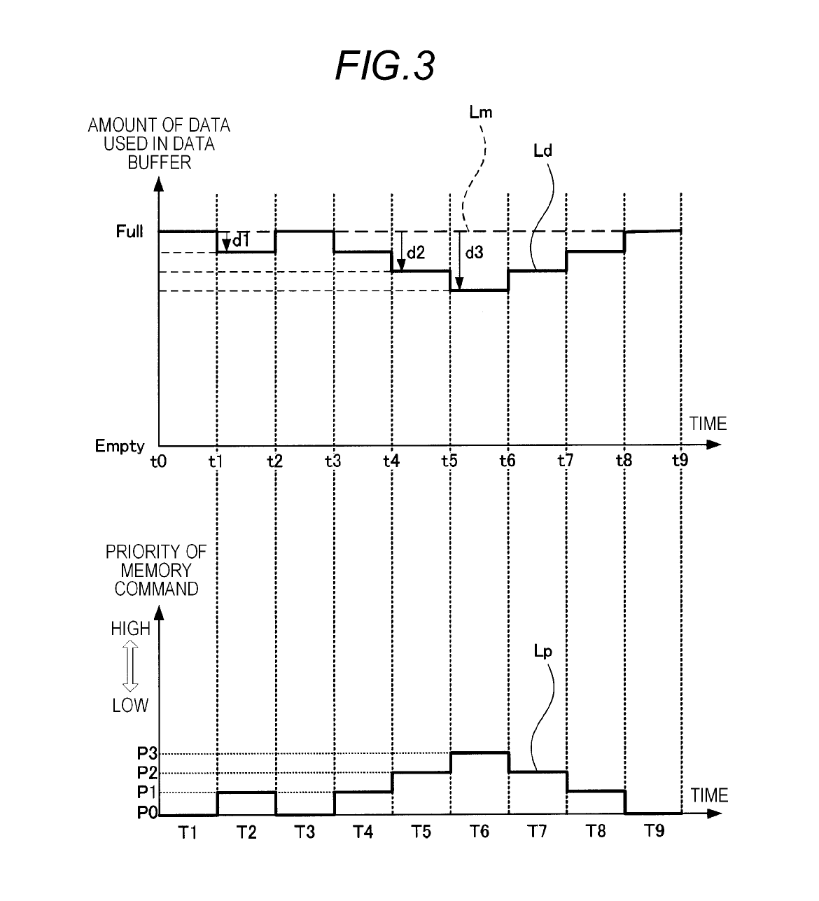

This point is a very different point from the data processing apparatus in the related art that does not issue a memory command to a bus master until the read data buffer 13 of the bus master is empty and issues a memory command intensively when the read data buffer 13 becomes empty. Compared with the data processing apparatus in the related art that performs such processing, according to the data processing apparatus 1 of the present embodiment, it is possible to greatly reduce the frequency at which the write data buffer 12 becomes full and the frequency at which the read data buffer 13 becomes empty. Therefore, as will be described later with reference to FIG. 3, it is possible to issue a read command being associated the priority information of low priority with the free space of the read data buffer 13.

That is, in the data processing apparatus 1 according to the present embodiment, the degree of freedom in the rearrangement processing of memory commands by the DRAM controller 31 that is a memory controller is increased by suppressing the number of issues of the memory command requiring a short latency, that is, the number of issues of the memory command of high priority. As a result, the throughput of the data processing apparatus as a whole is improved.

When contention occurs between a plurality of memory commands, the DRAM controller 31 executes memory commands being associated with priority information, which indicates a higher priority than other memory commands, in preference to the other memory commands.

That is, in the data processing apparatus 1 according to the present embodiment, when memory commands are issued by the bus master 10, the DRAM controller 31 rearranges the plurality of memory commands so as to be processed in order from the memory command of high priority with reference to the priority information being associated with each memory command.

FIG. 3 is a timing chart showing an example of the priority information generation process performed by the bus master provided in the data processing apparatus according to the embodiment of the present invention. Here, a process of generating the priority information based on the read command will be described.

In the graph shown in the upper part of FIG. 3, the horizontal axis indicates “time”, and the vertical axis indicates “amount of data used in a data buffer (read data buffer 13)”. In the graph shown in the upper part of FIG. 3, the dashed line Lm shows the maximum storage capacity of the read data buffer 13, and the solid line Ld shows a change in the amount of data used in the read data buffer 13. In the graph shown in the lower part of FIG. 3, the horizontal axis indicates “time”, and the vertical axis indicates “priority associated with a read command”. In the graph shown in the lower part of FIG. 3, the solid line Lp shows a change in the level of the priority indicated by the priority information.

The second detection circuit 15 detects free spaces d1, d2, d3, . . . at the respective times, generates priority information by determining the priority based on the read command issued at the corresponding time depending on the free spaces, and outputs the priority information to the processing unit 11 and the DRAM controller 31. Specifically, the second detection circuit 15 generates the priority information as follows.

In periods T1, T3, and T9 shown in FIG. 3, there is no free space in the read data buffer 13. Accordingly, it can be said that the possibility that the read data buffer 13 will become empty does not need to be considered in the periods T1, T3, and T9. Therefore, “priority information P0” that is the priority information indicating the minimum priority is associated with read commands issued in the periods T1, T3, and T9.

In periods T2, T4, and T8, free space d1 is generated in the read data buffer 13. Therefore, the second detection circuit 15 generates and outputs the priority information indicating the priority corresponding to the free space d1 in the periods T2, T4, and T8. Here, for convenience of explanation, the priority information corresponding to the free space d1 is referred to as “priority information P1”. That is, the priority information P1 is associated with the read commands issued in the periods T2, T4, and T8.

In the data processing apparatus 1 according to the present embodiment, as shown in FIG. 3, when free space is generated in the read data buffer 13 even if the free space is small, the processing unit 11 of the bus master 10 issues a read command of the priority corresponding to the size of the free space.

On the other hand, in the data processing apparatus in the related art, no read command is issued until the read data buffer 13 becomes completely empty. Therefore, the latency of the read command is increased. In the data processing apparatus in the related art, since a number of memory commands of high priorities are issued, there is a restriction on the rearrangement of the processing order of read commands by the DRAM controller that is a memory controller. As a result, since the degree of freedom of the rearrangement is reduced, the throughput of the apparatus as a whole is reduced.

In the data processing apparatus 1 according to the present embodiment that has been made in view of such a situation, as shown in FIG. 3, a read command is issued so that even small free space generated in the read data buffer 13 is not useless. Therefore, since the frequency at which the read data buffer 13 becomes empty is greatly reduced, the throughput of the data processing apparatus 1 as a whole is improved.

In periods T5 and T7, free space d2 that is a free space larger than the free space d1 is generated in the read data buffer 13. Therefore, the second detection circuit 15 generates and outputs the priority information indicating the priority corresponding to the free space d2 in the periods T5 and T7. In this example, for convenience of explanation, the priority information corresponding to the free space d2 is referred to as “priority information P2”. That is, the priority information P2 is associated with the read commands issued in the periods T5 and T7.

In a period T6, free space d3 that is a free space larger than the free space d2 is generated in the read data buffer 13. Therefore, the second detection circuit 15 generates and outputs the priority information indicating the priority corresponding to the free space d3 in the period T6. In this example, for convenience of explanation, the priority information corresponding to the free space d3 is referred to as “priority information P3”. That is, the priority information P3 is associated with the read command issued in the period T6.

In the priority information P0 to P3, a higher number given after P indicates a higher priority. As described above, the size of the free space d1 to d3 satisfies the relationship of d1<d2<d3. That is, in the data processing apparatus 1 according to the present embodiment, the priority information corresponding to the size of the free space of the read data buffer 13 is generated, and the read command associated with the priority information is output from the bus master 10.

Thus, in the data processing apparatus 1 according to the present embodiment, the priority of the issued read command is a priority corresponding to the free space of the read data buffer 13 at the time of issuance. Therefore, since each read command is issued with the appropriate priority, the throughput of the apparatus as a whole is also improved.

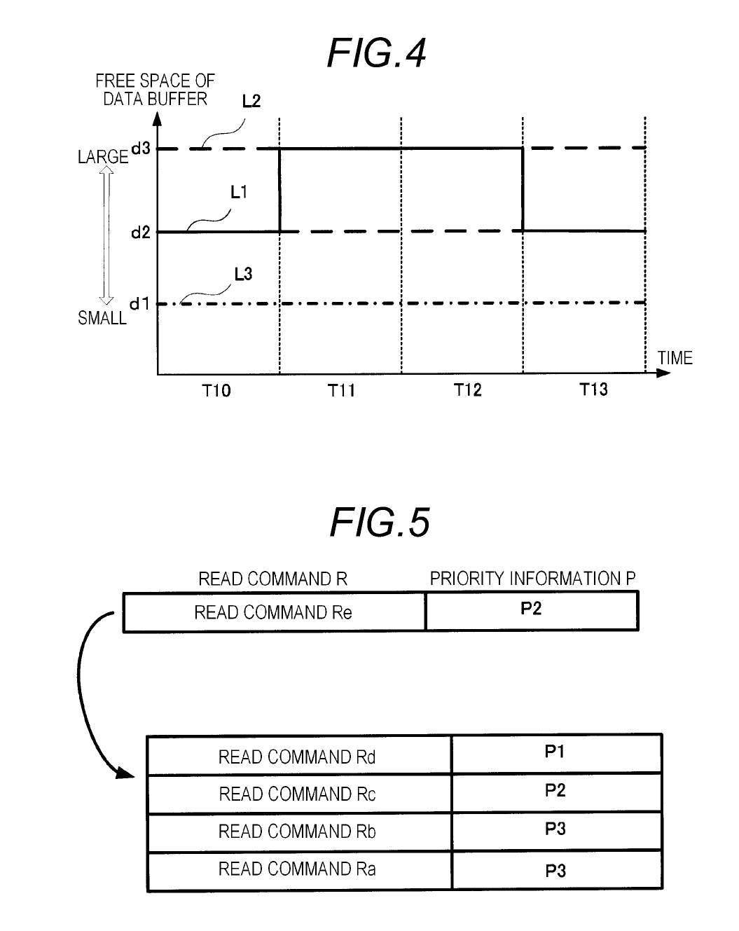

Hereinafter, an example of rearranging the read commands, which are issued by the plurality of bus masters 10-1, 10-2, and 10-3, when contention occurs between the read commands will be described. FIG. 4 is a graph of a temporal change in the free space of each read data buffer provided in the plurality of bus masters 10-1, 10-2, and 10-3. In the graph shown in FIG. 4, the vertical axis indicates the free space of the bus master 10, and the horizontal axis indicates time.

The solid line L1 shows a temporal change in the free space of the read data buffer provided in the first bus master 10-1. The dashed line L2 shows a temporal change in the free space of the read data buffer provided in the second bus master 10-2. The one-dot chain line L3 shows a temporal change in the free space of the read data buffer provided in the third bus master 10-3.

In periods T10 and T13, the free space of the first bus master 10-1 is d2, the free space of the second bus master 10-2 is d3, and the free space of the third bus master 10-3 is d1.

Therefore, in the periods T10 and T13, the priority information P2 is associated with the read command issued by the first bus master 10-1, the priority information P3 is associated with the read command issued by the second bus master 10-2, and the priority information P1 is associated with the read command issued by the third bus master 10-3.

That is, the priority of the read commands issued in the periods T10 and T13 is high in order of the second bus master 10-2, the first bus master 10-1, and the third bus master 10-3.

In periods T11 and T12, the free space of the first bus master 10-1 is d3, the free space of the second bus master 10-2 is d2, and the free space of the third bus master 10-3 is d1.

Therefore, in the periods T11 and T12, the priority information P3 is associated with the read command issued by the first bus master 10-1, the priority information P2 is associated with the read command issued by the second bus master 10-2, and the priority information P1 is associated with the read command issued by the third bus master 10-3.

That is, the priority of the read commands issued in the periods T11 and T12 is high in order of the first bus master 10-1, the second bus master 10-2, and the third bus master 10-3.

Hereinafter, the rearrangement of the processing order of read commands based on the priority information P associated with each read command by the above process will be described by way of an example. FIG. 5 is a diagram showing the concept of the rearrangement of the processing order of read commands that is performed by the DRAM controller 31 when contention occurs between a plurality of read commands.

In the example shown in FIG. 5, there is contention between five read commands Ra, Rb, Rc, Rd, and Re. The priority information P3 is associated with the read command Ra. The priority information P3 is associated with the read command Rb. The priority information P2 is associated with the read command Rc. The priority information P1 is associated with the read command Rd. The priority information P2 is associated with the read command Re.

In addition, the example shown in FIG. 5 is an example in which the four read commands Ra, Rb, Rc, and Rd are already input to the DRAM controller 31 and the read command Re is newly input to the DRAM controller 31 in that state.

As described above, in the priority information P in this example, a higher number given after P indicates a higher priority. Therefore, the priority information P2 associated with the read command Re newly input to the DRAM controller 31 has a higher priority than the priority information P1 already input to the DRAM controller 31.

In this situation, the DRAM controller 31 changes the processing order of the read command Re newly input to the DRAM controller 31 and the read command Rd that is associated with the priority information P of lower priority than the read command Re although the read command Rd has been previously input to the DRAM controller 31. That is, the DRAM controller 31 rearranges the processing order of the read commands Re and Rd based on the priority information P.

While the rearrangement processing of the read commands has been described as an example of the rearrangement processing of the memory commands, the point that “priority information is generated depending on the size of the free space of the write data buffer 12 provided in the bus master, and the processing order is rearranged based on the priority information” is the same for the rearrangement processing of write commands. However, the method of generating the priority information is different from that in the case of the read command in the following points.

That is, in the case of the read command, as the free space of the read data buffer 13 becomes larger, priority information of higher priority is generated by the second detection circuit 15. In the case of the write command, however, as the free space of the write data buffer 12 becomes smaller, priority information of higher priority is generated by the first detection circuit 14. Therefore, in the case of the write command, when the free space of the write data buffer 12 is zero, priority information of the highest priority is generated.

Based on the priority information generated as described above, the DRAM controller 31 rearranges the processing order of the write commands so as to be processed in order from the write command of higher priority.

In addition, by setting the priority information at a common scale for the read command and the write command, the processing order may be rearranged for a memory command group in which read commands and write commands are mixed.

As described above, according to the embodiment of the present invention, the priorities of memory commands issued by the respective bus masters 10-1, 10-2, 10-3, . . . are determined depending on the free space of each data buffer provided in the bus masters 10-1, 10-2, 10-3, . . . and the DRAM controller 31 rearranges the execution order of the memory commands based on the priorities. Therefore, since the efficiency of the memory access control becomes high by suppressing the number of issues of the memory command of high priority, it is possible to provide a data processing apparatus that realizes high throughput and a short latency with the simple configuration.

In the data processing apparatus in the related art, the priority of the memory command is set in a fixed manner by the bus master that issues the memory command. On the other hand, in the data processing apparatus 1 according to the present embodiment, the priority of the memory command is set depending on the free space of the write data buffer 12 and the read data buffer 13. Therefore, a situation where memory commands of high priorities are intensively issued is suppressed. In addition, the DRAM controller 31 rearranges the memory commands in consideration of the type of read and write or the memory address. Therefore, even if contention occurs between a plurality of memory commands issued by a plurality of bus masters, those memory commands are executed in an appropriate order in response to access across the banks, switching between writing and reading, and the like. As a result, the data processing apparatus 1 with high throughput and a short latency is realized.

While the present invention has been described with reference to the embodiment, it is needless to say that the present invention is not limited to the above-described example and various modifications and applications can be made within the scope of the present invention.

### (First Modification)

For example, when there is no free space in the read data buffer 13 as in the periods T1, T3, and T9 shown in FIG. 3, the second detection circuit 15 may be configured to generate “information that prohibits the issuance of a read command” instead of issuing the “priority information P0” indicating the minimum priority and output it to the processing unit 11. In this case, in the periods T1, T3, and T9, the processing unit 11 that receives the “information that prohibits the issuance of a read command” output from the second detection circuit 15 does not issue a read command.

### (Second Modification)

For example, instead of using the priority information (hereinafter, referred to as first priority information) set depending on the free space of the data buffers 12 and 13 described above, a mode (hereinafter, referred to as a “priority fixed mode”) in which priority information (hereinafter, referred to as second priority information), which is obtained by setting the priority based on the memory command issued by each bus master in advance for each bus master, is used may be set so that switching between the priority fixed mode and a mode (hereinafter, referred to as a “priority change mode”), in which a process specific to the embodiment described above is performed, is possible. In the priority fixed mode, for example, the DRAM controller 31 may be configured to include a register (not shown), and it is preferable to set the second priority information for each bus master using the register (not shown).

Thus, by configuring the priority fixed mode and the priority change mode to be switched therebetween, it is possible to set the processing order of memory commands in consideration of viewpoints other than the viewpoint of improving the throughput of the data processing apparatus 1 as a whole. That is, in addition to the processing as to improve the throughput of the data processing apparatus 1 as a whole, the memory command issued by the specific bus master can be always processed with a predetermined priority (for example, the highest priority).

In this modification, the DRAM controller 31 functions as a setting information acquisition unit that acquires the second priority information which defines an order for preferentially processing the memory commands for each bus master that issues the memory commands. In addition, the DRAM controller 31 functions as a processing order determination unit that determines the processing order of the memory commands based on either the first priority information or the second priority information in response to the instruction from the outside of the data processing apparatus.

Inventions of various stages are included in the embodiment and the modifications described above, and various aspects of the present invention can be extracted by appropriately combining a plurality of constituent elements disclosed. For example, when the problem described in the summary of the invention can be solved even if some constituent elements are deleted from all the constituent elements shown in the embodiment, the configuration in which the constituent elements are deleted can be also extracted as an aspect of the present invention.

What is claimed is:

1: A data processing apparatus, comprising:
a plurality of bus masters; and
a memory controller that is connected to the plurality of bus masters and a memory in which data is stored to transfer the data, wherein the memory controller is adapted to control at least one of writing of data to the memory and reading of data from the memory, wherein
each of the plurality of bus masters includes:
a command issuing unit that is adapted to issue a memory command to specify access to the memory;
a data buffer; and
a priority information generating unit that is adapted to generate first priority information depending on a free space of the data buffer, wherein the first priority information is associated with the memory command and indicates a priority of the memory command, and
the memory controller includes:
a processing order determining unit that is adapted to determine a processing order of memory commands which are issued by the plurality of bus masters based on the first priority information corresponding to the memory commands; and
a command processing unit that is adapted to execute the respective memory commands transferred from the plurality of bus masters in the processing order determined by the processing order determining unit.

2: The data processing apparatus according to claim 1, wherein
the memory controller includes a priority information acquisition unit that is adapted to acquire second priority information which defines an order for preferentially processing the memory commands for each bus master that issues the memory commands, and
the processing order determining unit determines the processing order of the memory commands based on either the first priority information or the second priority information in response to an instruction from an outside of the memory controller.

3: The data processing apparatus according to claim 1, wherein
the data buffer includes a write data buffer in which write data to be written in the memory is stored,
the command issuing unit issues a write command as the memory command when the write data is written to the memory, and
the priority information generating unit generates the first priority information which defines that a write command issued when a free space of the write data buffer is small is executed in preference to a write command issued when the free space is large.

4: The data processing apparatus according to claim 1, wherein
the data buffer includes a read data buffer in which read data to be read from the memory is stored,
the command issuing unit issues a read command as the memory command when the read data is read from the memory, and
the priority information generating unit generates the first priority information which defines that a read command issued when a free space of the read data buffer is large is executed in preference to a read command issued when the free space is small.

5: The data processing apparatus according to claim 1, wherein the memory is a dynamic random access memory (DRAM).

6: A memory apparatus, comprising:
a memory in which data is stored;
a plurality of bus masters; and
a memory controller that is connected to the plurality of bus masters and the memory to transfer the data, wherein the memory controller is adapted to control at least one of writing of data to the memory and reading of data from the memory, wherein
each of the plurality of bus masters includes:
a command issuing unit that is adapted to issue a memory command to specify access to the memory;
a data buffer; and
a priority information generating unit that is adapted to generate first priority information depending on a free space of the data buffer, wherein the first priority information is associated with the memory command and indicates a priority of the memory command, and
the memory controller includes:
a processing order determining unit that is adapted to determine a processing order of memory commands which are issued by the plurality of bus masters based on the first priority information corresponding to the memory commands; and
a command processing unit that is adapted to execute the respective memory commands transferred from the plurality of bus masters in the processing order determined by the processing order determining unit.
